(19) United States
(12) Patent Application Publication
(10) Pub. No.: US 2023/0246528 A1
(43) Pub. Date: Aug. 3, 2023

(54) METHOD FOR PRODUCING A SKEWED STATOR

(71) Applicant: VALEO EAUTOMOTIVE GERMANY GmbH, Erlangen (DE)

(72) Inventors: Regina BACH, Bad Neustadt a.d. Saale (DE); Sebastian BEETZ, Bad Neustadt a.d. Saale (DE); Boris DOTZ, Bad Neustadt a.d. Saale (DE); Christian FINGER-ALBERT, Bad Neustadt a.d. Saale (DE); Carsten SIEPKER, Bad Neustadt a.d. Saale (DE); Sebastian WAIDER, Bad Neustadt a.d. Saale (DE)

(73) Assignee: VALEO EAUTOMOTIVE GERMANY GmbH, Erlangen (DE)

(21) Appl. No.: 18/002,639

(22) PCT Filed: Jun. 11, 2021
(86) PCT No.: PCT/EP2021/065732

§ 371 Date: Dec. 20, 2022

(30) Foreign Application Priority Data
Jun. 22, 2020 (DE) 10 2020 116 383.5

(51) Int. Cl. H02K 15/02; H02K 15/00; H02K 15/04

(52) U.S. Cl. CPC H02K 15/024; H02K 15/0031; H02K 15/0421; H02K 15/0012; H02K 2201/06

(57) ABSTRACT

A method for producing a skewed stator having a stator winding made from segmented conductors includes providing a stator core having a large number of axially layered stator core elements which form a plurality of slots extending from one end-face of the stator core to an opposite end-face, and which extend parallel in an axial direction. A large number of segmented conductors are provided which each have two leg portions extending parallel to each other and a connection portion electrically connecting the leg portions. The leg portions are introduced into the slots, and the stator core elements are rotated in a circumferential direction so they are displaced relative to each other in a circumferential direction and the slots form an inclination in a circumferential direction. The leg portions are bent by the rotation have an inclination corresponding to the slots. The stator core elements are fixed relative to each other.

The present invention relates to a method for producing a skewed stator, which has stator windings made from segmented conductors.

In order to prevent undesirable cogging torques and torque ripples during operation of an electrical machine, it is generally known to use a skewed stator and/or a skewed rotor.

The document CN 109 639 078 A discloses a method for producing a stator arrangement of a motor with hair pin windings, comprising the following steps: providing a stator core with a skewed slot; providing a large number of hair pins with a square cross sectional surface-area; rotating legs of the hair pins in accordance with a helical shape of the inclined slots so that an angle of the legs corresponds to an angle of the slots; grouping free ends of the legs of a plurality of rotated hair pins to form a cage; inserting the cage in the stator core by rotation; and electrically connecting the free ends to form pairs in order to form a winding.

An object of the invention is to provide an improved method for producing a skewed stator, which has a stator winding made of segmented conductors.

This object is achieved according to the invention by a method for producing a skewed stator which has a stator winding made from segmented conductors, comprising the following steps: providing a stator core which has a large number of axially layered stator core elements, wherein the stator core elements form slots of the stator core which extend from a first end face of the stator core to an opposite second end face of the stator core and which extend parallel in an axial direction; providing a large number of segmented conductors which each have two leg portions which extend parallel to each other and a connection portion which connects the leg portions in an electrically conductive manner; introducing the leg portions into the slots; rotating stator core elements of the stator core in a circumferential direction so that the stator core elements are displaced relative to each other in a circumferential direction and the slots form an inclination in a circumferential direction, wherein the leg portions are bent by the rotation and receive an inclination corresponding to the inclination of the slots; and fixing the stator core elements relative to each other so that the inclination of the slots is maintained.

The invention is based on the consideration of enabling the production of a skewed stator which has a stator winding made of segmented conductors in that the non-inclined segmented conductors are introduced into the stator core which is provided in a non-inclined manner, according to which, as a result of the stator core elements being rotated, not only the inclination of the slots of the stator core is formed, but the leg portions are simultaneously bent in accordance with the inclination of the slots. Thus, a continuously inclined stator with, as far as possible, an optimum reduction of cogging torques and torque ripples during operation of an electrical machine can be produced. So to speak, the advantages of a stator winding made from segmented conductors, in particular the simple production and the enabling of a high degree of automation in comparison with windings made from round wires are afforded. The stator, which is obtained by the method according to the invention advantageously, further allows use of a non-inclined rotor, which quite substantially reduces the production costs of an electrical machine. Furthermore, as a result of the method according to the invention, it is advantageously possible to dispense with bending of the leg portions in a separate method step before introduction into the slots, which simplifies the production process.

A segmented conductor, which can also be referred to as a hair pin conductor, is particularly characterized in that it is made from massive metal, in particular from copper. Typically, the segmented conductor has a, where applicable rounded, rectangular cross section. The segmented conductor is advantageously not constructed to be flexurally loose. The leg portions of the segmented conductor are typically rod-shaped. Preferably, the leg portions are constructed in terms of their cross section so that a predetermined number of leg portions, for example, a maximum of 16 leg portions, preferably a maximum of 12 leg portions, in a particularly preferable manner a maximum of eight leg portions, fill in a radially layered manner inside a slot at least 40%, preferably at least 60%, in a particularly preferable manner at least 80%, and/or a maximum of 90%, preferably a maximum of 80%, of the cross sectional surface-area of the slot. There may further be provision for an even number of leg portions, in particular at least two leg portions, preferably at least four leg portions, more preferably at least six leg portions, in a particularly preferable manner at least eight leg portions, to be introduced into a respective slot. In particular, there is provision in the method according to the invention for the leg portions and the slots to extend linearly in an axial direction, preferably directly, before the step of rotation, and only during the step of rotation for the respective inclination to be obtained. Typically, the leg portions and the connection portion, which connects them, are integrally constructed.

The stator core is particularly a sheet metal assembly.

The stator core elements are in particular stator metal sheets or individual metal sheets which each have, for example, a thickness of from 0.27 mm to 0.5 mm.

In the method according to the invention, the step of providing the stator core can particularly include the following sub-steps: providing a large number of stator core elements, preferably by stamping, and arranging the stator core elements in such a manner that the through-openings of the stator core elements are located one above the other in a congruent manner. The stator core elements are advantageously provided in a manner electrically insulated relative to each other. In other words, the stator core elements are not fixed in their relative positions. The stator core elements are typically provided or arranged stacked loosely one on the other.

The introduction of the leg portions in the slots is advantageously carried out so that the leg portions extend axially through all the stator core elements and/or free ends of the leg portions project out of the stator core at the second end face. Typically, the leg portions also move at least a portion of the stator core elements, in particular the stator core elements, which are located between the external stator core elements, in the rotation step. There may particularly be provision for only a portion of the stator core elements to be actively rotated, preferably one of the external stator core elements or both external stator core elements, and for the remaining stator core elements to also rotate as a result of the bending of the leg portions.

In a preferred embodiment of the method according to the invention, there is provision, for rotation, for the external stator core element at the first end face and/or portions, which project at the first end face out of the stator core, of the segmented conductors to be retained by means of a first retention tool. Alternatively or additionally, the external stator core element at the second end face and/or portions, which project at the second end face out of the stator core, of the segmented conductors are retained by means of a second retention tool. The projecting portions are typically part of a winding overhang of the stator winding.

Furthermore, a rotational movement can be carried out in a circumferential direction of the retention tools relative to each other so that the leg portions also move the stator core elements which are arranged between the external stator core elements. Advantageously, both retention tools are rotated in opposite directions. However, it is also possible for the first retention tool to be securely retained and for the rotational movement to be applied to the second retention tool, or for the second retention tool to be securely retained and the rotational movement to be applied to the first retention tool.

In a particularly preferable manner, there is provision for the first retention element and/or the second retention element to comprise radially movable retention elements and the retention elements to have a radial projection for each slot. In this case, the projections can be moved radially inwardly at angular positions between the slots and can retain at that location the portions, which project out of the stator core, of the segmented conductors. Thus, the retention elements can be fitted from the exterior to the projecting portions with little complexity. The projections preferably extend radially inwardly no further than an internal diameter of the stator core. Preferably, each retention element has two, in particular precisely two, projections.

It is further advantageous if the first retention element and/or the second retention element has/have an annular frame, which is fixed to the stator core in order to retain the external stator core element. Typically, the frame extends radially outwardly over the external diameter of the stator core. Furthermore, the frame can extend radially inwardly no further than an external radial position of the slots. Advantageously, the frame is placed on the end face of the stator core before the rotation step.

In a development, there may be provision for the retention elements to be mounted in the frame radially movable. Thus, there is produced a compact retention tool which can retain both the projecting portions and the external stator core elements. After the positioning, in particular after the fixing, of the frame, the retention elements can be moved radially inwardly.

In the method according to the invention, it is preferable for the inclination of the slots and/or the leg portions to be helical. The helical inclination—or inclination, which is screw-like, in other words—is particularly characterized by a constant thread height and/or an inclination angle, which is constant in the axial direction.

It is further preferable in the method according to the invention for the stator core elements to be rotated until an axial opening of a respective slot is located in a circumferential direction at the first end face at an angular position, at which an axial opening of a directly adjacent slot is located at the second end face. An inclination, which is particularly advantageous from an electromagnetic point of view and for reducing the cogging torques and the torque ripples, can thereby, be produced around a slot division.

In the method according to the invention, there is preferably used a segmented conductor whose connection portions are bent in such a manner that the leg portions of the segmented conductor produce an offset by a plurality of slots in a circumferential direction and/or an offset by one or more layers in a radial direction. The provision of the segmented conductors can include bending an elongate, electrically conductive rod so that the parallel leg portions and/or the connection portion, which produces the offset in a circumferential direction and/or radial direction, are constructed. It is possible for the connection portion to be constructed by rotational tensile bending, for example, by means of a 3D bending apparatus.

The segmented conductors are particularly provided or arranged for provision in such a manner that leg portions of different segmented conductors can be introduced radially layered into the slots. Typically, a maximum of one leg portion is located at a radial position in a slot, respectively. The segmented conductors are preferably provided in a state arranged in accordance with a predetermined winding diagram of the stator winding.

In an advantageous embodiment of the method according to the invention, there may be provision for so many segmented conductors to be provided, that the leg portions of the segmented conductors fill radially layered all the slots of the stator core. Such an arrangement of the segmented conductors can also be referred to as the segmented conductor basket. Thus, the segmented conductors can be promptly introduced into the stator core in one operating step. The segmented conductors are particularly introduced into the slots in such a manner that they completely fill all the slots or fill them to such an extent that only individual additional segmented conductors have to be introduced for connecting the stator winding, for example, for forming phase connections and/or for constructing one or more star point connectors.

In the method according to the invention, there may be provision for an electrically insulating slot liner to be or become introduced into a respective slot before the leg portions are introduced, which slot liner is accordingly deformed during the step of rotating the inclination of the slots. The term “slot liner” is particularly intended to be understood to be a device which extends over the entire axial extent of the slot and which completely lines the slot in a circumferential direction in order to electrically insulate the interior of the slot against the stator core. Typically, such a slot liner is made from insulating paper. It is preferable for the material of the slot liner to be selected so that it conforms to a surface of the slots during the rotation step.

In order to prevent damage to the slot liners, it is particularly preferable for free ends of the leg portions not to touch the slot liners during introduction of the leg portions. Alternatively or additionally, there may be provision for the first retention tool and/or the second retention tool to prevent damage to the slot liners during the rotation step.

The stator core elements are preferably fixed by materially engaging joining, in particular by welding, for example, laser welding.

In particular, following the fixing, the following additional step can be provided in the context of the method according to the invention: bending free ends of a respective leg portion at the second end face so that the free ends of different segmented conductors abut each other. Additionally, the following step may be provided: electrically conductive connection of the mutually abutting free ends. The connection is preferably carried out by a joining method, in particular by welding, preferably laser welding.

Additional advantages and details of the present invention will be appreciated from the embodiments, which are described below and with reference to the drawings. These drawings are schematic illustrations in which:

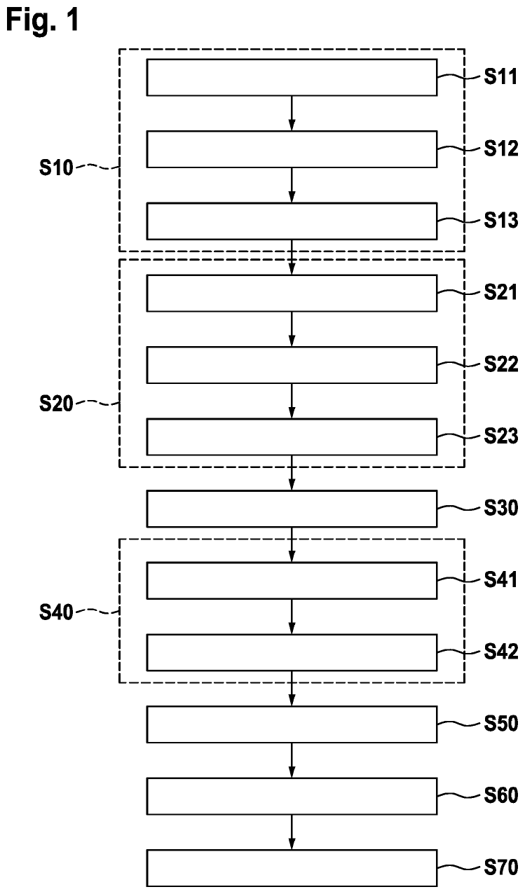

FIG. 1 shows a flow diagram of an embodiment of the method according to the invention;

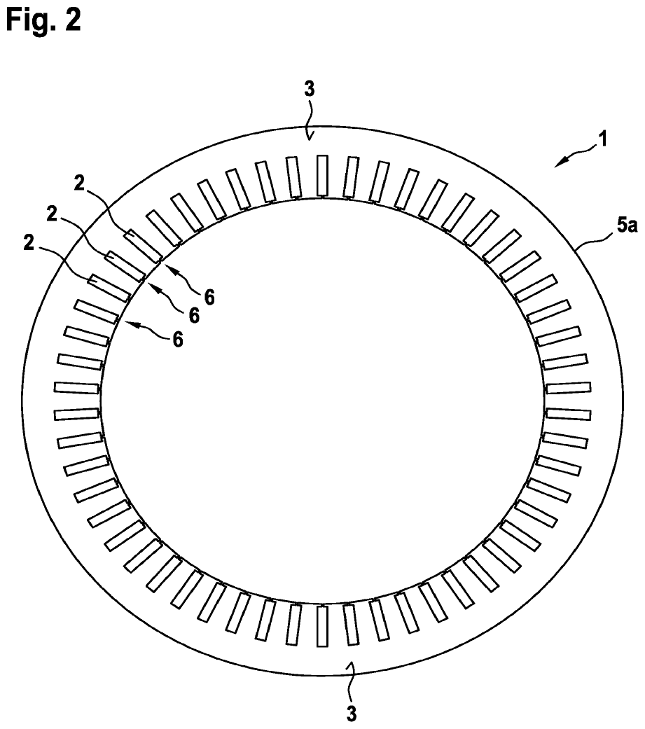

FIG. 2 shows a front view of a stator core, which is used in the context of the method;

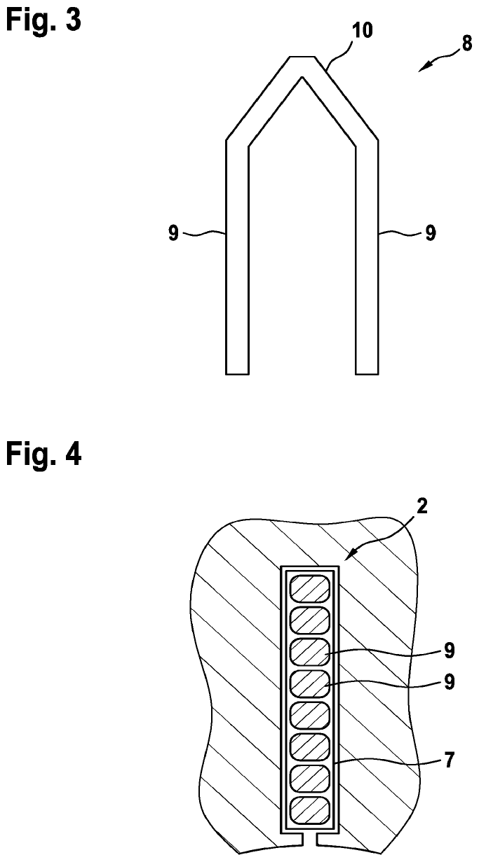

FIG. 3 shows a schematic view of a segmented conductor which is used in the context of the method;

FIG. 4 shows a schematic view of a slot with leg portions, which are arranged therein, of the segmented conductors;

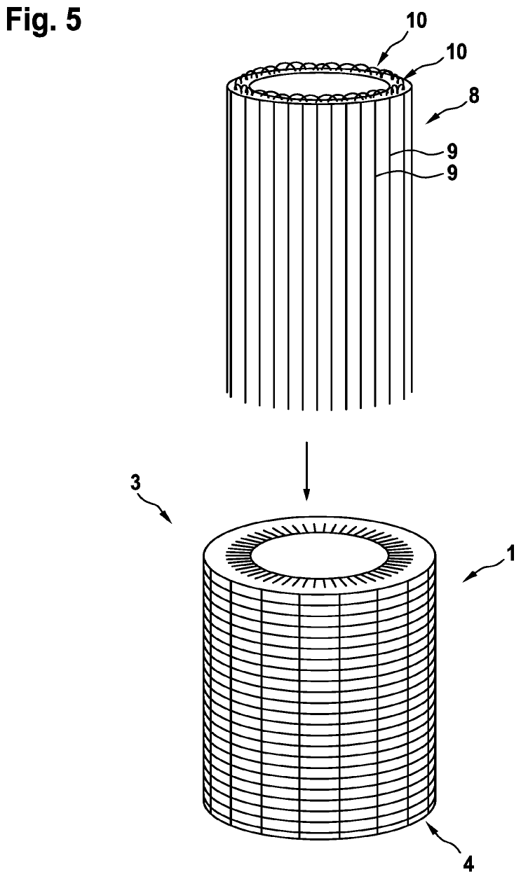

FIG. 5 shows a schematic view of an operation for introducing segmented conductors in the stator core in the context of the method;

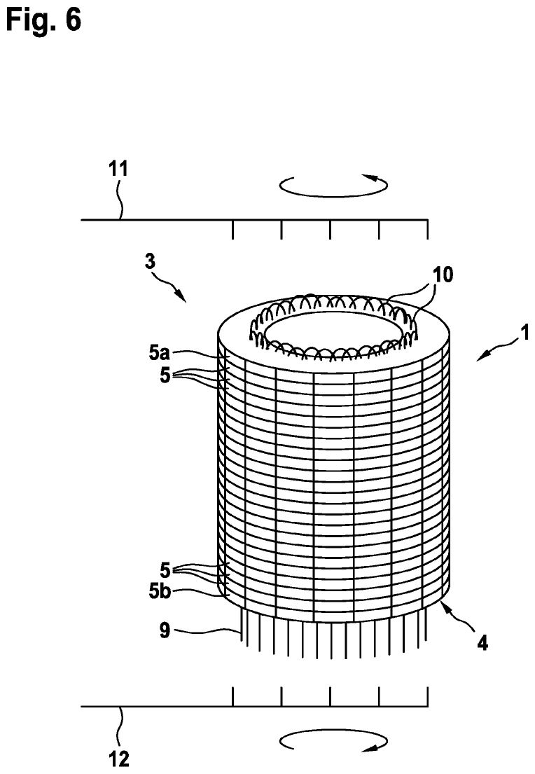

FIG. 6 shows a schematic view of the segmented conductors introduced into the stator core;

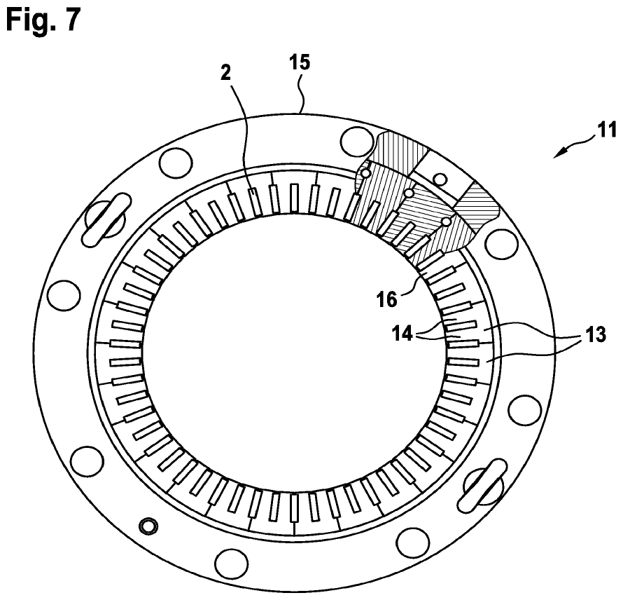

FIG. 7 shows a partially sectioned front view of a retention tool which is used in the context of the method in a position which is arranged on the stator core; and

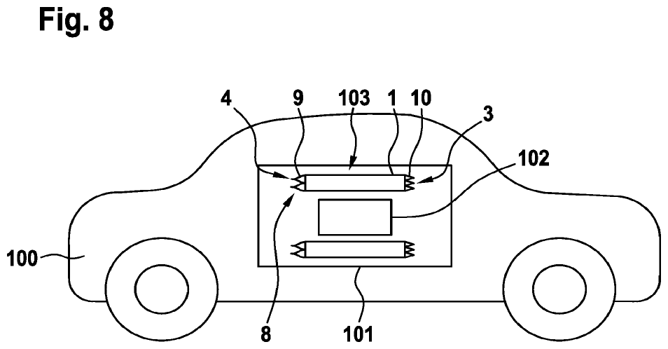

FIG. 8 shows an example of a vehicle having an electrical machine, which has a stator, which is obtained by the method according to the invention.

FIG. 1 shows a flow diagram of an embodiment of a method according to the invention for producing a skewed stator.

The method comprises a first step S10, in which a stator core 1, which is in particular in the form of a sheet metal assembly, is provided.

FIG. 2 shows a front view of the stator core 1.

In this case, the stator core 1 comprises by way of example 54 slots 2 which extend from a first end face 3 which is shown in FIG. 2 to an opposite second end face 4 (see FIG. 3). The stator core 1 has a large number of axially layered stator core elements 5, 5a, 5b (see also FIG. 6), in particular in the form of individual metal sheets or stator metal sheets which are, for example, from 0.27 mm to 0.5 mm thick. FIG. 2 shows an axially external stator core element 5a at the first end face 3. Each stator core element 5, 5a, 5b has a large number of through-openings 6 which form the slots 2 of the stator core 1. In this case, the through-openings 6 of the stator core elements 5, 5a, 5b are arranged loosely one on the other in a congruent manner so that the slots 2 extend parallel in an axial direction.

The step S10 of providing the stator core 1 comprises in this embodiment three sub-steps S11 to S13: in the sub-step S11, the large number of stator core elements 5, 5a, 5b, which are typically formed by stamping are provided. In the subsequent sub-step S12, the stator core elements 5 are arranged, in an axially layered state, loosely one on the other so that the through-openings 6 form the linear extending slots 2. In the sub-step S13, an electrically insulating slot liner 7 which is made from insulating paper is introduced into each slot 2 (see FIG. 4), which slot liner 7 extends completely in an axial direction between the end faces 3, 4 and completely lines the slot 2 in a circumferential direction.

FIG. 3 shows a schematic view of a segmented conductor 8, which is used in the context of the method. FIG. 4 shows a schematic view of a slot 2 with segmented conductors 8 received therein.

The segmented conductor 8 comprises two leg portions 9, which extend in a parallel manner in an axial direction and a connection portion 10, which connects the leg portions 8 in an electrically conductive manner. The connection portion 10 is constructed in such a manner that the leg portions 9, when they are introduced into the slots 2, are arranged in different slots 2 and in different radial layers inside a respective slot 2. To this end, FIG. 4 shows that eight leg portions 9 in eight layers of a slot 2 which is lined by the slot liner 2 fill approximately 80% of the cross sectional surface—are of the slot 2. In an evident manner, the leg portions 9 have a cross section, which is rectangular in a rounded manner. In this case, each segmented conductor 8 is made from copper, wherein the leg portions 9 are constructed integrally with the connection portion 10.

FIG. 5 shows a schematic illustration of an operation for introducing segmented conductors 8 into the stator core 1 in the context of the method.

In a step S20 of the method, the segmented conductors 8 are provided. The step S20 comprises in this embodiment three sub-steps S21 to S23:

In the sub-step S21, a rod made of copper is provided. This rod is bent in the sub-step S22 so that, on the one hand, the connection portion 10 is formed and, on the other hand, the leg portions 9, which extend parallel to each other, are formed. The formation of the connection portion 10 is preferably carried out by rotational tensile bending, for example, by means of a 3D bending apparatus.

In the sub-step S23, so many segmented conductors 8 in the form of a segmented conductor basket are arranged in such a manner that the leg portions 9 of the segmented conductors 8 in a radially layered state completely fill or virtually fill all the slots 2 of the stator core 1. The segmented conductors 8 are arranged in such a manner that all the connection portions 10 are located at one axial end and all the free ends of the leg portions 9 are located at the other axial end of the segmented conductor basket.

In a step S30, the leg portions 9 are introduced into the slots 2 by a linear relative movement between the stator core 1 and the segmented conductors 8. The free ends of the leg portions 9 are introduced from the first end face 3 into the slots 2 until the free ends of the leg portions 9 project at the second end face 4 from the stator core 1. In this case, the free ends of the leg portions 9 do not touch the slot liners 7.

FIG. 6 is a schematic illustration of the segmented conductors 8, which are introduced into the stator core 1.

In a step S40, stator core elements 5, 5a, 5b of the stator core 1 are subsequently rotated in a circumferential direction so that the stator core elements 5, 5a, 5b are displaced relative to each other in a circumferential direction and the slots 2 form an inclination in a circumferential direction. In this case, the leg portions 9 are bent by the rotation and receive an inclination, which corresponds to the inclination of the slots 2.

The step S40 comprises the following sub-steps S41 and S42:

In the sub-step S41, the external stator core element 5a at the first end face 3 and portions, which project at the first end face 3, of the segmented conductors 8 are retained by means of a first retention tool 11, that is to say, substantially transition portions from the connection portion 10 to the leg portions 9. In a manner of speaking, the external stator core element 5b at the second end face 4 and portions, which project at the second end face 4, of the segmented conductors 8, that is, parts of the leg portions 9, are retained by means of a second retention tool 12. The retention tools 11, 12 are purely schematically illustrated in FIG. 6.

FIG. 7 is a partially sectioned front view of the first retention tool 11 in a position arranged on the stator core 1. The explanations relating to the first retention tool 11 apply similarly to the identically constructed second retention tool 12 in this case.

The first retention tool 11 comprises a number of retention elements 13 corresponding to the number of slots 2. The retention elements 13 as a whole have for each slot 2 a projection 14. Each retention element 13 comprises two projections 14 which are arranged at angular positions between the slots 2 and which retain every second projecting portion at both sides at that location. The projecting portions which are located therebetween are each retained at one side by a projection 14 of a pair of directly adjacent retention elements 13.

The first retention tool 11 further comprises an annular frame 15 which overlaps an external diameter of the stator core 1 in the position shown in FIG. 7. The retention elements 13 are mounted in a radially movable manner inside the frame 15. In the position of the retention elements 13 as shown in FIG. 7, they are in the radially innermost position thereof. In this case, in an evident manner, the projections 14 do not reach further in an inward direction than an internal diameter of the stator core 1 so that tooth heads 16 of the stator core 1 can be seen in FIG. 7.

In the sub-step S41, the first retention tool 11 is placed on the first end face 3 and the second retention tool 12 is placed on the second end face 4 from the axial direction. In this case, the retention elements 13 are located in the radially outermost position thereof in the frame 15. The frame 15 of the first retention tool 11 is fixed to the axially outermost stator core element 5a in order to retain it. Similarly, the frame 15 of the second retention tool 12 is fixed to the axially outermost stator core element 5b in order to retain it. Subsequently, the retention elements 13 of the retention tools 11, 12 are moved radially inwardly in order to retain the projecting portions of the segmented conductors 8.

In the sub-step S42, as can be seen in FIG. 6, the retention tools 11, 12 are rotated relative to each other in a circumferential direction so that the leg portions 9 also move the stator core elements 5, which are arranged, between the external stator core elements 5a, 5b. To this end, both retention tools 11, 12 are rotated in the present embodiment in opposite directions in a circumferential direction. According to alternative embodiments, the first retention tool 11 remains fixed during the rotational movement and only the second retention tool 12 is rotated in a circumferential direction, or vice versa.

In a subsequent step S50, the stator core elements 5, 5a, 5b are fixed relative to each other so that the inclination of the slots 2 is maintained. To this end, a plurality of weld seams are constructed at the radially external covering face of the stator core 1 by laser welding.

In a subsequent step S60, the free ends of the leg portions 9 are bent at the second end face 4 so that free ends of two different leg portions 9 abut each other. In a subsequent step S70, the abutting free ends are connected to each other in an electrically conductive manner and in a materially engaging manner by means of laser welding.

FIG. 8 shows a schematic illustration of an example of a vehicle 100 with an electrical machine 101, which has a stator 103, which is obtained by a method according to one of the above-described embodiments.

A non-inclined rotor 102 is rotatable mounted relative to the stator 103 inside the stator 103 of the electrical machine 101, which is in this case in the form of a permanently excited synchronous motor by way of example. It can be seen that only connection portions 10 of the segmented conductors 8 are located at the first end face 3 of the stator core 1 and only the welded free ends of the leg portions 9 of the segmented conductors 8 are located at the second end face 4 of the stator core 1.

The electrical machine 101 is configured to drive the vehicle 100. This vehicle 100 is in the form of a partially or completely electrically drivable vehicle, for example, a battery electric vehicle (BEV) or a hybrid vehicle.

1. A method for producing a skewed stator which has a stator winding made from segmented conductors, comprising the following steps:
providing a stator core which has a large number of axially layered stator core elements, wherein the stator core elements form a plurality of slots of the stator core which extend from a first end face of the stator core to an opposite second end face of the stator core and which extend parallel in an axial direction;
providing a large number of segmented conductors which each have two leg portions which extend parallel to each other and a connection portion which connects the leg portions in an electrically conductive manner;
introducing the leg portions into the slots;
rotating stator core elements of the stator core in a circumferential direction so that the stator core elements are displaced relative to each other in a circumferential direction and the slots form an inclination in a circumferential direction, wherein the leg portions are bent by the rotation and receive an inclination corresponding to the inclination of the slots; and
fixing the stator core elements relative to each other so that the inclination of the slots is maintained.

2. The method according to claim 1, wherein in the rotation step
the external stator core element at the first end face and/or portions, which project at the first end face out of the stator core, of the segmented conductors are retained by means of a first retention tool, and
the external stator core element at the second end face and/or portions, which project at the second end face out of the stator core, of the segmented conductors are retained by means of a second retention tool,
and a rotational movement is carried out in a circumferential direction of the retention tools relative to each other so that the leg portions also move the stator core elements which are arranged between the external stator core elements.

3. The method according to claim 2, wherein the first retention tool and/or the second retention tool comprise(s) radially movable retention elements and the retention elements have a radial projection for each slot, wherein the projections are moved radially inwardly at angular positions between the slots and retain at that location the portions, which project out of the stator core, of the segmented conductors.

4. The method according to claim 2, wherein the first retention tool and/or the second retention tool has/have an annular frame which is fixed to the stator core in order to retain the external stator core element.

5. The method according to claim 3, wherein the retention elements are mounted in the frame radially movable.

6. The method according to claim 1, wherein
the inclination of the slots and/or the leg portions is helical.

7. The method according to claim 1, wherein the stator core elements are rotated until an axial opening of a respective slot is located in a circumferential direction at the first end face at an angular position, at which an axial opening of a directly adjacent slot is located at the second end face.

8. The method according claim 1, wherein
as many segmented conductors are provided that the leg portions of the segmented conductors fill radially layered all the slots of the stator core.

9. The method according to claim 1, wherein an electrically insulating slot liner is or becomes introduced into a respective slot before the leg portions are introduced, which slot liner is accordingly deformed during the step of rotating the inclination of the slots.

10. The method according to claim 2, wherein the first retention tool and/or the second retention tool has/have an annular frame which is fixed to the stator core in order to retain the external stator core element.

11. The method according to claim 2, wherein the retention elements are mounted in the frame radially movable.

12. The method according to claim 2, wherein
the inclination of the slots and/or the leg portions is helical.

13. The method according to claim 2, wherein the stator core elements are rotated until an axial opening of a respective slot is located in a circumferential direction at the first end face at an angular position, at which an axial opening of a directly adjacent slot is located at the second end face.

14. The method according claim 2, wherein
as many segmented conductors are provided that the leg portions of the segmented conductors fill radially layered all the slots of the stator core.

15. The method according to claim 2, wherein an electrically insulating slot liner is or becomes introduced into a respective slot before the leg portions are introduced, which slot liner is accordingly deformed during the step of rotating the inclination of the slots.

16. The method according to claim 3, wherein the first retention tool and/or the second retention tool has/have an annular frame which is fixed to the stator core in order to retain the external stator core element.

17. The method according to claim 3, wherein the retention elements are mounted in the frame radially movable.

18. The method according to claim 3, wherein
the inclination of the slots and/or the leg portions is helical.

19. The method according to claim 3, wherein the stator core elements are rotated until an axial opening of a respective slot is located in a circumferential direction at the first end face at an angular position, at which an axial opening of a directly adjacent slot is located at the second end face.

20. The method according claim 3, wherein
as many segmented conductors are provided that the leg portions of the segmented conductors fill radially layered all the slots of the stator core.
